(19) United States
(12) Patent Application Publication
(10) Pub. No.: US 2017/0113582 A1
(43) Pub. Date: Apr. 27, 2017

(54) ADJUSTMENT MECHANISM FOR A HEAD RESTRAINT

(71) Applicant: Johnson Controls Technology Company, Holland, MI (US)

(72) Inventors: Eric B. MICHALAK, Northville, MI (US); Jeff D. LAHO, Canton, MI (US); John R. DAVIS, Milford, MI (US); Joseph A. Wolkowicz, Livonia, MI (US); Nathan A. Caruss, Ann Arbor, MI (US)

(73) Assignee: Johnson Controls Technology Company, Holland, MI (US)

(21) Appl. No.: 15/303,678

(22) PCT Filed: May 13, 2015
(86) PCT No.: PCT/US2015/030553

§ 371 Date: Oct. 12, 2016

Related U.S. Application Data
(60) Provisional application No. 61/993,052, filed on May 14, 2014.

(51) Int. Cl. B60N 2/48

(52) U.S. Cl. CPC B60N 2/4808; B60N 2/4811; B60N 2/4882

(57) ABSTRACT

A vertical and contour adjustment mechanism for a head restraint may include a frame, a vertical adjuster, a vertical lock, a contour adjuster, a contour lock, and a user interface. The frame may include first and second lateral portions. The vertical adjuster may be configured to allow adjustment of a vertical position of the frame. The vertical lock may be movable between a locked position and an unlocked position. The contour adjuster may be configured to allow adjustment of lateral positions of the first lateral portion and the second lateral portion. The contour lock may be movable between a locked position and an unlocked position. The user interface may be configured to be engaged by a user to simultaneously control movement of the vertical lock between the locked position and the unlocked position and control movement of the contour lock between the locked position and the unlocked position.

### CROSS-REFERENCE TO RELATED PATENT APPLICATIONS

This application claims priority to and the benefit of U.S. Provisional Patent Application No. 61/993,052, filed May 14, 2014, the entire disclosure of which is incorporated herein by reference.

### FIELD

The present application relates generally to adjustment mechanisms for head restraints.

### BACKGROUND

Head restraints, which may be located on the top of a seat, may have a mechanism, release, or control, such as a push-button, to release or unlock the head restraint in order for the head restraint height (vertical position relative to the seat) to be adjusted. Typically, the control is located away from the head restraint itself Thus, in order to raise or lower the head restraint, the user must push or activate the control with one hand while moving the head restraint with the other hand, thus requiring the user to use two hands and further resulting in uncomfortable and difficult head restraint adjustment. Further, in order to minimize the amount of “buzz, squeak, rattle” (BSR) and “noise, vibration, harshness” (NVH) and since the locking mechanism alone may not be sufficient to sufficiently reduce BSR and NVH, the sliding friction to move the head restraint may be relatively high. Therefore, the control and the head restraint may require a significant amount of effort and force to activate and to move, respectively, further reinforcing the need to use both hands to adjust the head restraint.

Additionally, the contours of such a head restraint, typically are not adjustable. Often, the head restraint will have a static outer shape.

### SUMMARY

According to one embodiment, a vertical and contour adjustment mechanism for a head restraint may include a frame, a vertical adjuster, a vertical lock, a contour adjuster, a contour lock, and a user interface. The frame may include a first lateral portion and a second lateral portion. The vertical adjuster may be configured to allow adjustment of a vertical position of the frame. The vertical lock may be movable between a locked position, in which the vertical adjuster is locked to prevent adjustment of the vertical position of the frame, and an unlocked position, in which the vertical adjuster is unlocked to allow adjustment of the vertical position of the frame. The contour adjuster may be configured to allow adjustment of lateral positions of the first lateral portion and the second lateral portion. The contour lock may be movable between a locked position, in which the contour adjuster is locked to prevent adjustment of the lateral positions of the first and second lateral portions, and an unlocked position, in which the contour adjuster is unlocked to allow adjustment of the lateral positions of the first and second lateral portions. A user interface may be configured to be engaged by a user to simultaneously control movement of the vertical lock between the locked position and the unlocked position and control movement of the contour lock between the locked position and the unlocked position.

According to another embodiment, a vertical adjustment mechanism for a head restraint may include a frame, a vertical adjuster, a vertical lock, a user interface, and a flexible linkage. The vertical adjuster may be configured to allow adjustment of a vertical position of the frame. The vertical lock may be movable between a locked position, in which the vertical adjuster is locked to prevent adjustment of the vertical position of the frame, and an unlocked position, in which the vertical adjuster is unlocked to allow adjustment of the vertical position of the frame. The user interface may be configured to be engaged by a user to control movement of the vertical lock between the locked position and the unlocked position. The flexible linkage may connect the user interface and the vertical lock to control movement of the vertical lock.

According to yet another embodiment, a contour adjustment mechanism for a head restraint may include a frame, a contour adjuster, a contour lock, and a user interface. The frame may include a first lateral portion and a second lateral portion. The contour adjuster may be configured to allow adjustment of lateral positions of the first lateral portion and the second lateral portion. The contour adjuster may include a gear mechanism on each of the first lateral portion and the second lateral portion and adjustment of the lateral position of one of the first and second lateral portions may cause a corresponding adjustment of the lateral position of the other of the first and second lateral portions. The contour lock may be movable between a locked position, in which the contour adjuster is locked to prevent adjustment of the lateral positions of the first and second lateral portions, and an unlocked position, in which the contour adjuster is unlocked to allow adjustment of the lateral positions of the first and second lateral portions. The user interface may be configured to be engaged by a user to control movement of the contour lock between the locked position and the unlocked position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Features, aspects, and advantages of the present invention will become apparent from the following description, and the accompanying exemplary embodiments shown in the drawings, which are briefly described below.

FIG. 1 is a perspective view of a vehicle according to one embodiment.

FIG. 2 is a perspective view of a vehicle seat that can be disposed in the vehicle of FIG. 1.

FIG. 3 is a rear, schematic view of an embodiment of a vertical and contour adjustment mechanism that can be disposed on the vehicle seat on FIG. 2.

FIG. 4 is a rear, schematic view of an embodiment of a vertical adjustment mechanism that can be disposed on the vehicle seat on FIG. 2.

FIG. 5 is a rear, schematic view of an embodiment of a contour adjustment mechanism that can be disposed on the vehicle seat on FIG. 2.

FIG. 6 is a front perspective view of the adjustment mechanism of FIG. 3.

FIG. 7 is a top plane view of the adjustment mechanism of FIG. 3.

FIG. 8 is a side elevational view of the adjustment mechanism of FIG. 3.

FIG. 9 is a rear perspective view of the adjustment mechanism of FIG. 3 without a back panel in a locked position and an unlocked position.

FIG. 10 is a rear elevational view of the adjustment mechanism of FIG. 3 without a back panel in the locked position.

FIG. 11 is a rear elevational view of the adjustment mechanism of FIG. 3 in a locked position.

FIG. 12 is a rear elevational view of the adjustment mechanism of FIG. 3 in an unlocked position.

FIG. 13 is a partially cross-sectional, front perspective view of the adjustment mechanism of FIG. 3.

FIG. 14 is a cross-sectional, rear perspective view of the adjustment mechanism of FIG. 3.

FIG. 15 is a cross-sectional, side elevational view of the adjustment mechanism of FIG. 3 in a locked position.

FIG. 16 is a cross-sectional, side elevational view of the adjustment mechanism of FIG. 3 in an unlocked position.

FIG. 17 is a cross-sectional view of Section 17 of FIG. 9.

FIG. 18 is a front perspective view of the adjustment mechanism of FIG. 3 with the first and second lateral portions angled toward each other.

FIG. 19 is a top plan view of the adjustment mechanism of FIG. 3 with the first and second lateral portions angled toward each other.

FIG. 20 is a front elevational view of the adjustment mechanism of FIG. 3 with the first and second lateral portions angled toward each other.

FIG. 21 is a cross-sectional view of Section 21 of FIG. 10.

FIG. 22 is a cross-sectional view of Section 22 of FIG. 10.

FIG. 23 is a cross-sectional, side view of the adjustment mechanism of FIG. 3 in the locked position.

FIG. 24 is a cross-sectional, side view of the adjustment mechanism of FIG. 3 in the unlocked position.

FIG. 25 is a rear elevational view of an adjustment mechanism in the locked position with the first and second lateral portion angled toward each other, according to another embodiment.

FIG. 26 is a rear elevational view of the contour lock of the adjustment mechanism of FIG. 25 in an unlocked position.

FIG. 27 is a cross-sectional, top view of the contour lock of the adjustment mechanism of FIG. 25 in a locked position.

FIG. 28 is a rear elevational view of the contour lock of the adjustment mechanism of FIG. 25 in the locked position and the unlocked position.

FIG. 29 is a cross-sectional, top view of a contour lock of an adjustment mechanism in a locked position, according to another embodiment.

FIG. 30 is a rear perspective view of an adjustment mechanism according to yet another embodiment.

FIG. 31 is a close-up, rear perspective view of a contour adjuster and a contour lock of the adjustment mechanism of FIG. 30.

FIG. 32 is a cross-sectional, top view of the adjustment mechanism of FIG. 3 in the locked position.

FIG. 33 is a cross-sectional, top view of the adjustment mechanism of FIG. 3 in the unlocked position.

FIG. 34 is a rear perspective view of an adjustment mechanism according to another embodiment.

FIG. 35 is a rear elevational, schematic view of the adjustment mechanism of FIG. 34.

FIG. 36 is a partially transparent, front perspective view of an adjustment mechanism according to one embodiment.

FIG. 37 is a perspective view of a frame of the adjustment mechanism of FIG. 36.

### DETAILED DESCRIPTION

Referring generally to the figures, disclosed herein is an adjustment mechanism for a head restraint, as shown according to exemplary embodiments, that can allow the height of the head restraint to be adjusted relative to a seat and/or allow the head restraint to have adjustable contour. The head restraint and methods described herein may be used in a variety of applications, such as within a vehicle. The head restraint is also useful in any non-vehicle application wherein it would be desirable to adjust a head restraint relative to a seat and/or to adjust the contours of the head restraint according to the user's preferences.

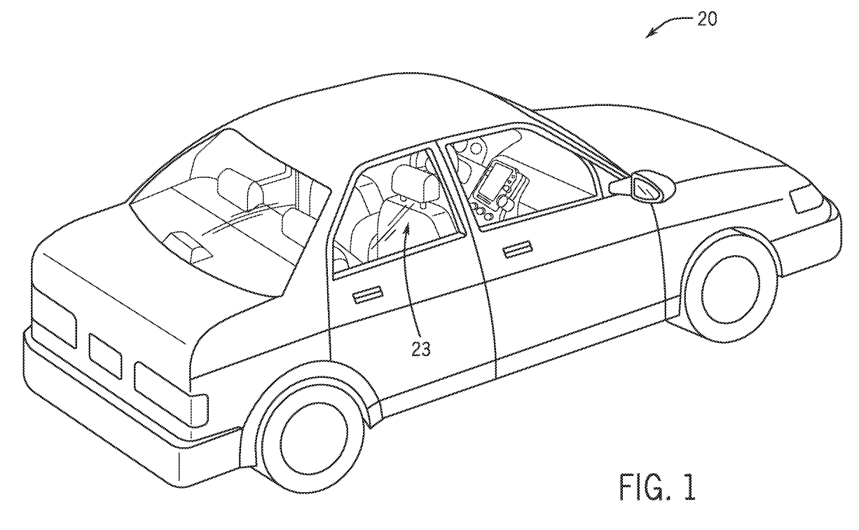

FIG. 1 illustrates an embodiment of a vehicle 20 that may include a head restraint with an adjustment mechanism. The vehicle 20 may include an interior passenger compartment containing a vehicle seat 23 for providing seating to an occupant. Although a four door sedan automobile is shown in FIG. 1, the head restraint may be used in a variety of applications and in any types of vehicle, such as a two door or four door automobile, a truck, a SUV, a van, a train, a boat, an airplane, or other suitable vehicular conveyance.

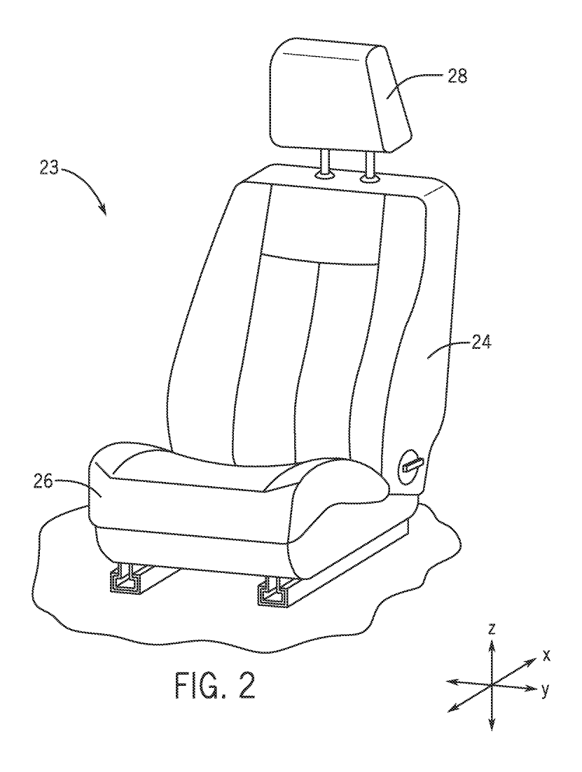

According to one embodiment as depicted in FIG. 2, a vehicle seat 23 may include a seat back 24 and a seat cushion 26. A head restraint or head rest 28 may be mounted or attached to the seat back 24. The head rest 28 may be useful in preventing whiplash and providing head support to an occupant of the seat 23. The seat 23 may include a seat support 29, which may be a portion of the seat back 24 or of the seat frame.

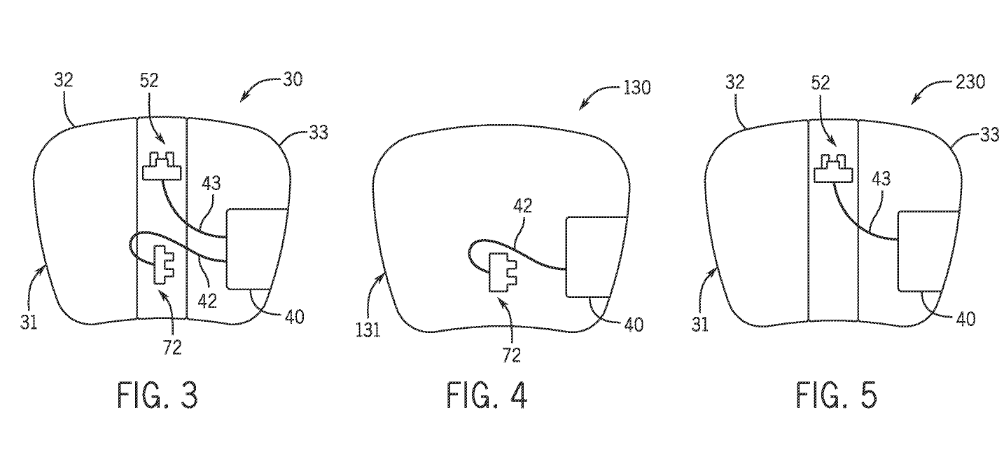

The head rest 28 may include an adjustment mechanism 30, 130, or 230 with at least one of a vertical adjuster 70 and a contour adjuster 50 in order to adjust the vertical position and/or the contour of the frame 31 of the head rest 28. The vertical adjuster 70 may allow the vertical position or height of the frame 31 to be adjusted relative to the seat 23. The contour adjuster 50 may allow the curvature or contour of the frame 31 to be adjusted. A vertical lock 72 and a contour lock 52 can be used to prevent adjustment of the vertical adjuster 70 and the contour adjuster 50, respectively, to securely maintain the position of the frame 31 during normal use and in the event of an accident and may further allow adjustment when the user activates the user interface 40 (as described further herein). As shown in FIG. 3, the adjustment mechanism 30 may include both a vertical lock 72 and a contour lock 72 to lock a vertical adjuster 70 and a contour lock 50 that allow both the height and the contour of the frame 31 to be adjusted. As shown in FIG. 4, the adjustment mechanism 130 may include only the vertical lock 72 to lock the vertical adjuster 70 that allows the vertical position of the frame 131 to be adjusted. As shown in FIG. 5, the adjustment mechanism 230 may include only the contour lock 52 to lock the contour adjuster 50 that allows the contour of the frame 31 to be adjusted.

### The Frame

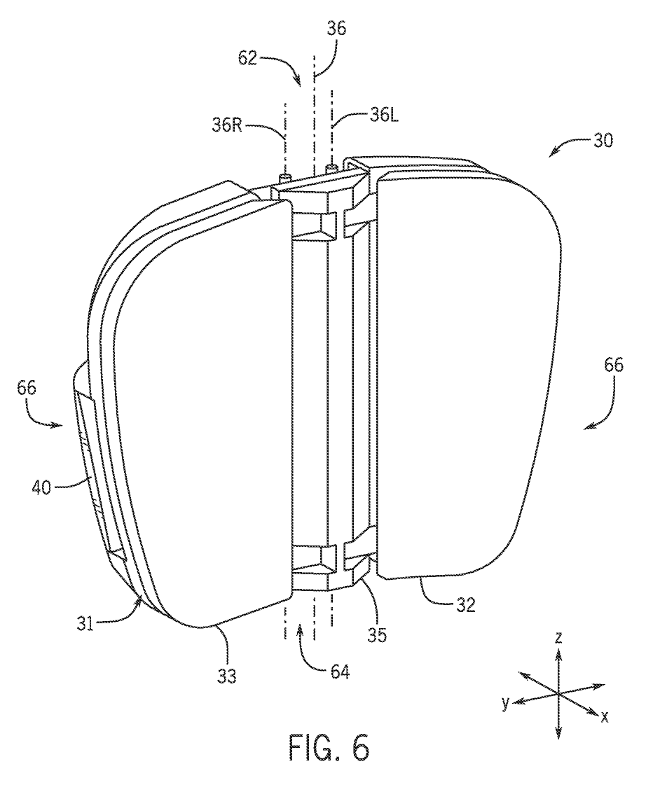

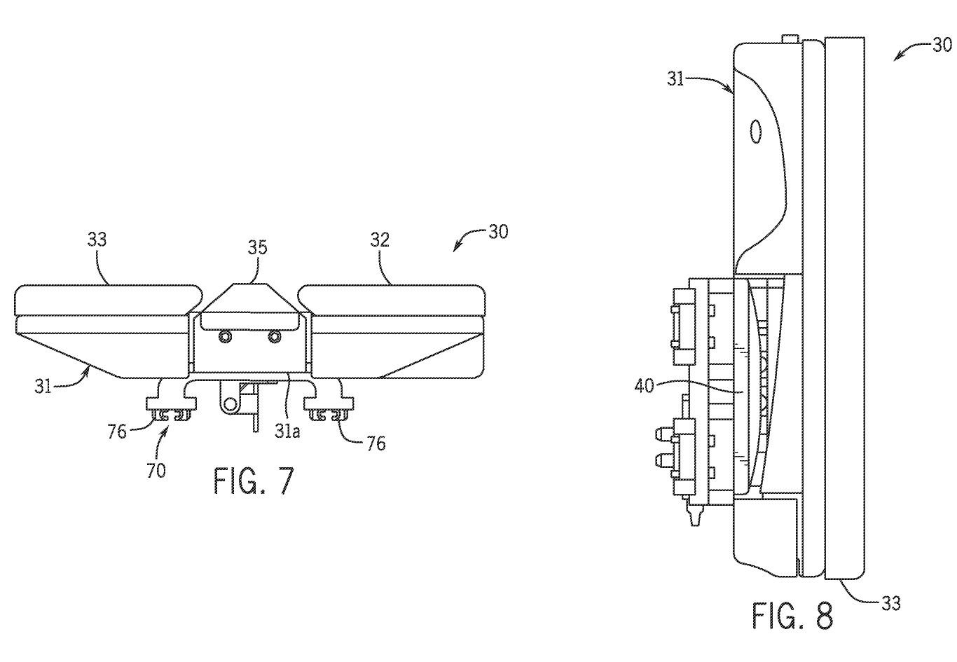

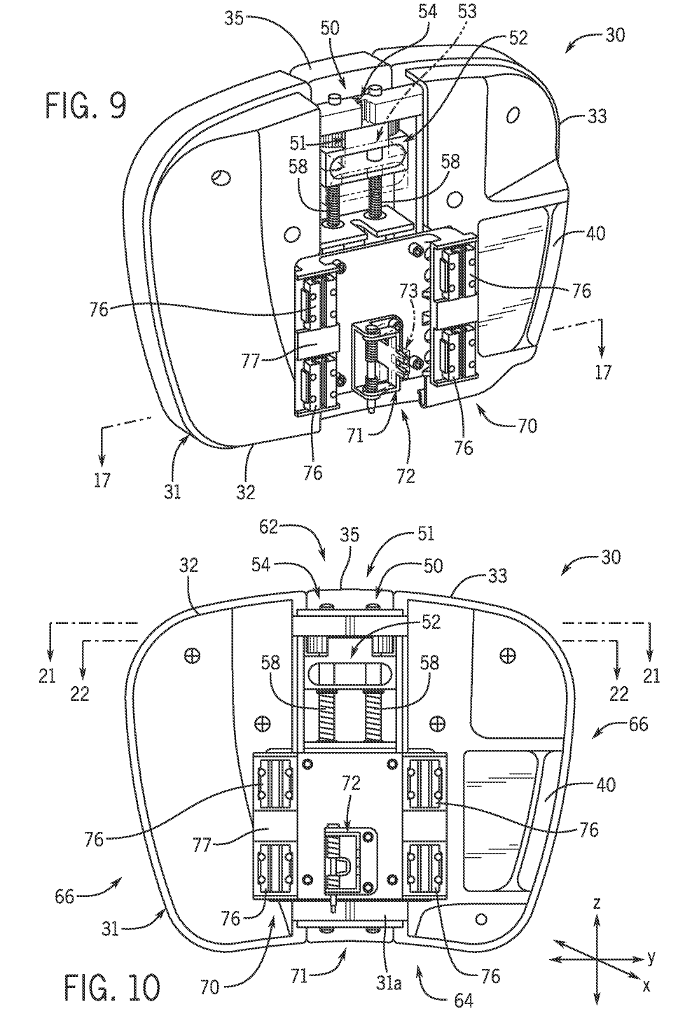

As shown in FIGS. 6-12, the adjustment mechanism 30 includes a frame 31. The frame 31 may be a head restraint or may be a portion of a head restraint. Trim, foam, and/or other protective or decorative members may be added to the frame 31. A front side of the frame 31 (shown in FIG. 6) may be configured to support a head of a passenger. A back side of the frame 31 (shown in FIGS. 9-10) may be configured to attach to a portion of the seat 23, such as a seat support 29.

The frame 31 may include a support member 3 la, a first lateral side, wing, or portion 32, and a second lateral side, wing, or portion 33 that are adjustable relative to the support member 31a and to each other substantially about a center axis 36 (as described further herein). The center axis 36 may be substantially vertical (e.g., extending along the z-axis) and disposed substantially at the middle or a center portion of the frame 31 for equal adjustment of the first and second lateral portions 32 and 33 and a smaller overall package of the frame 31. As shown in FIG. 6, while the first and second lateral portions 32 and 33 pivot substantially about the center axis 36, their precise pivot axes can be slightly offset from the center axis 36. In particular, the first lateral portion 32 can pivot about axis 36L, and the second lateral portion 33 can pivot about axis 36R. This slight offset of the pivot axes 36L and 36R can allow the frame 31 to include a center portion 35 that is positioned between the first and second lateral portions 32 and 33. The center portion 35 may provide additional support and/or an attachment area for the first and second lateral portions 32 and 33.

### The Vertical Adjuster

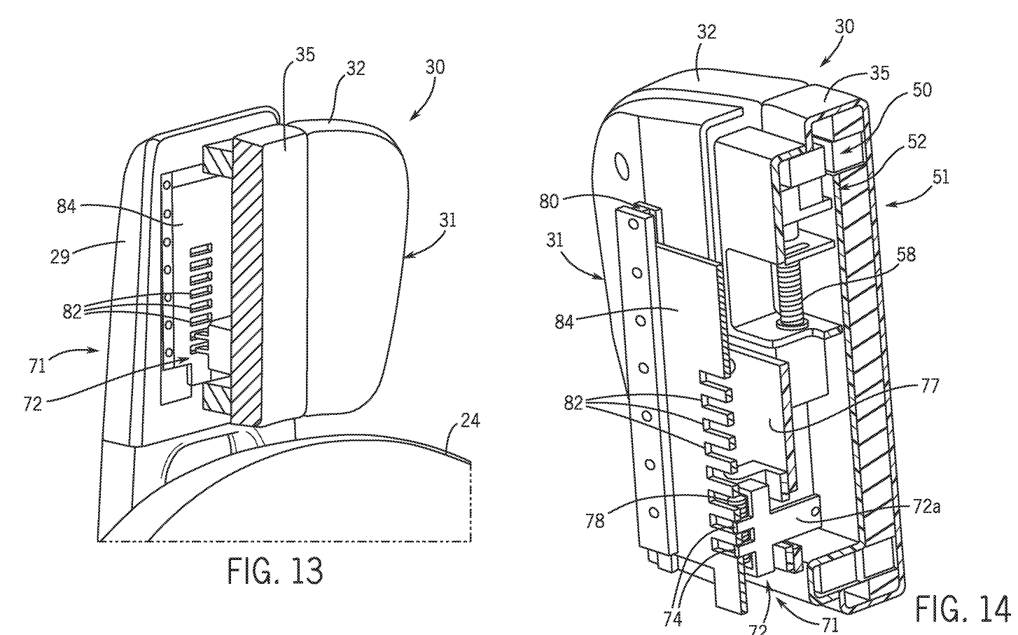

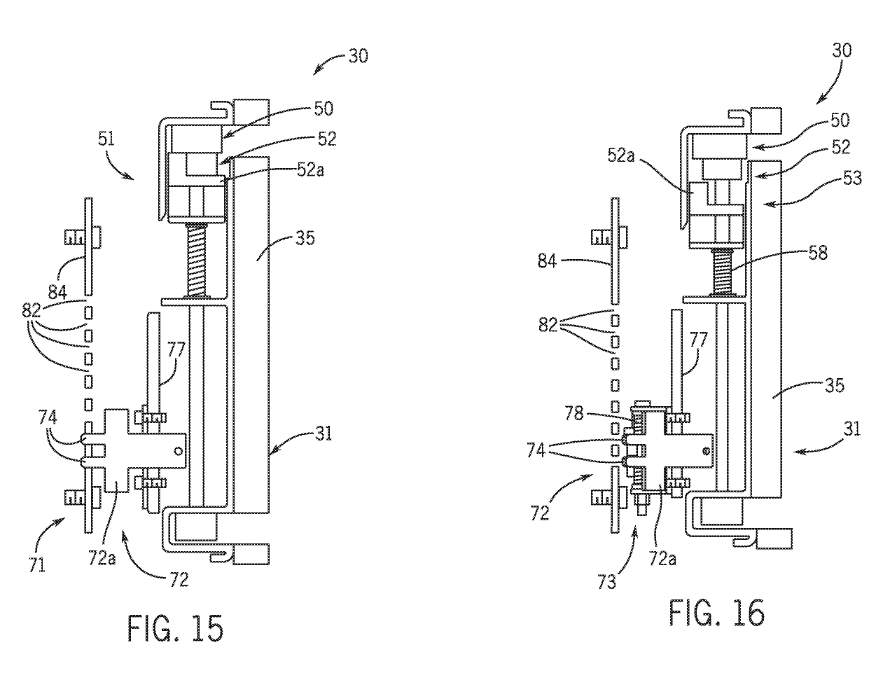

As shown in FIGS. 13-17, the vertical adjuster 70 may be used to allow the vertical position of the frame 31 to be adjusted relative to the seat back 24. It may be beneficial to adjust the height of the frame 31 in order to accommodate occupants of different sizes.

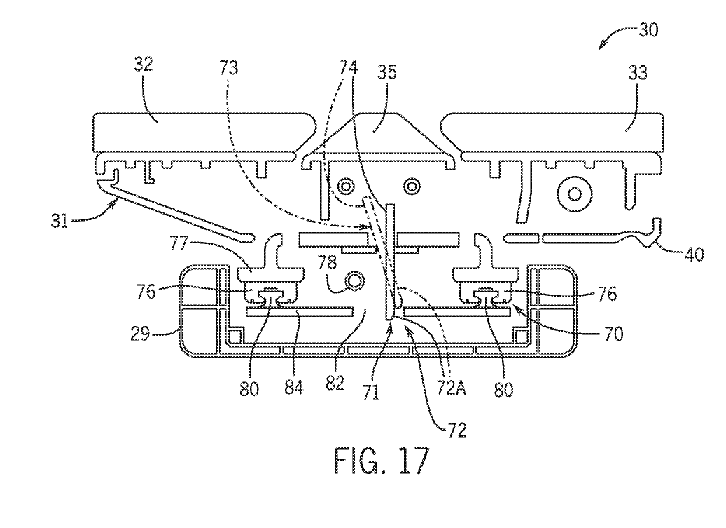

As shown in FIG. 17, the vertical adjuster 70 includes at least one vertical slide 76 (attached to, and preferably fixed in position relative to, the frame 31) that is movable or slidable along, within, around, or over at least one guide rail 80 (attached to, and preferably fixed in position relative to, a portion of the seat 23, such as the seat support 29) in order to adjust the vertical position of the frame 31 relative to the seat 23. The vertical adjuster 70 can include a support plate 77 on which the vertical slide 76 can be mounted or supported. The support plate 77 can be attached to the support member 31 a such that the support plate 77 is fixed in position relative to the frame 31. The rails 80 may be integrated into or statically attached directly to the seat support 29 or to a seat support plate 84 that is attached to the seat support 29. However, it is understood that the vertical slide 76 may be positioned on the seat support 29 and the rails 80 may be positioned on the frame 31. The connection between the vertical slides 76 and the rails 80 may help guide, support, and stabilize the frame 31 as the frame 31 is being vertically adjusted. Ball bearings or rollers may optionally be included between the vertical slides 76 and the rails 80.

### The Vertical Lock

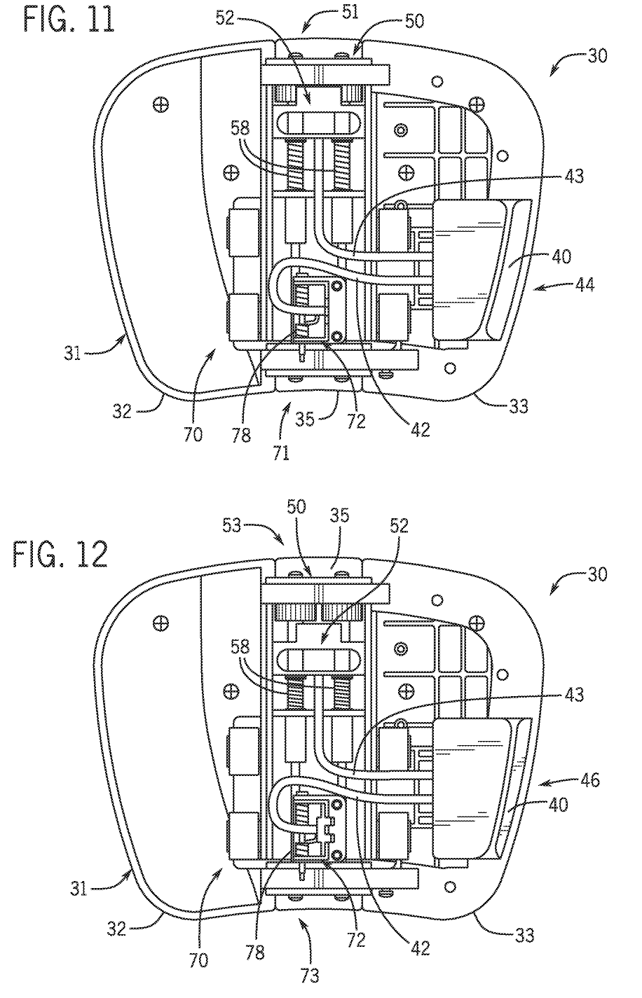

As shown in FIGS. 11-17, a pawl, locking lever, or vertical lock 72 may be used to lock and unlock the vertical adjuster 70 by moving between a locked position 71 and an unlocked position 73. When the vertical lock 72 is in the locked position 71, the vertical adjuster 70 is locked, thus preventing adjustment of the vertical position of the frame 31 and maintaining the vertical position. When the vertical lock 72 is in the unlocked position 73, the vertical adjuster 70 is unlocked, thus allowing adjustment of the vertical position of the frame 31.

The vertical lock 72 may be oriented or positioned anywhere along the frame 31 and may be fixed relative to and movable with the frame 31. For example, as shown in FIG. 14, the vertical lock 72 can be fixed to the support plate 77, which in turn is fixed to the support member 31a of the frame 31. Alternatively, the vertical lock 72 can be fixed directly to the frame 31. As also shown in FIG. 14, the vertical lock 72 may extend from a back side of the frame 31 near the bottom of the frame 31 and toward the seat support 29. It is understood that the vertical lock 72 may be located on a different area of the frame 31.

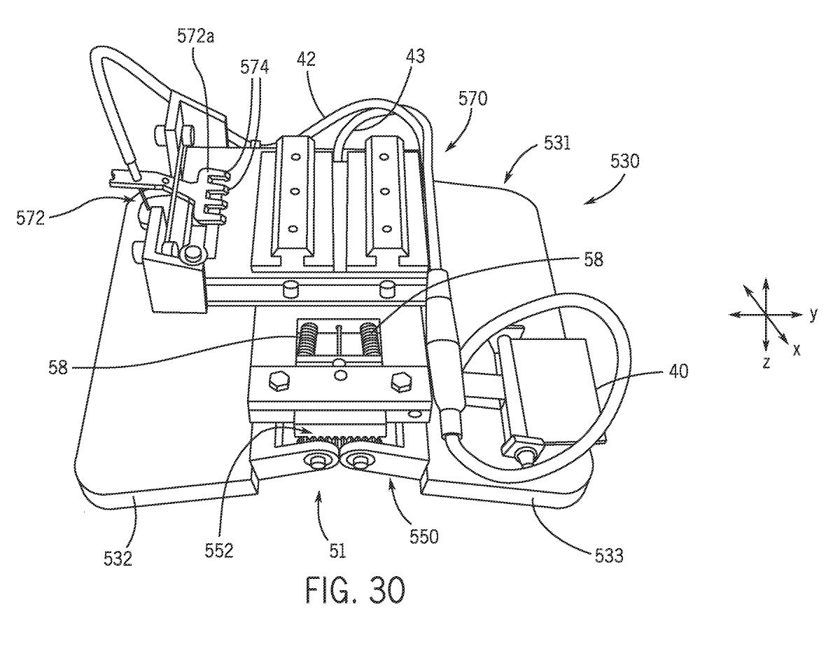

As shown in FIGS. 13 and 14, the vertical lock 72 may include a projection member 72a having at least one tooth, extension, finger, or projection 74 that interlocks with at least one of a series of apertures, holes, notches, or indentations 82 through a step engagement. The projection member 72a of the vertical lock 72 may include any number of projections 74, according to the desired configuration. As shown in FIG. 14, the projection member 72a includes two projections 74. According to another embodiment as shown in FIG. 30, the projection member 572a includes four projections 574. Depending on the number of projections 74 and the number of indentations 82, multiple projections 74 may engage with multiple indentations 82 to allow the frame 31 to be firmly locked into position and to manage the load.

The indentations 82 should be fixed in position relative to the seat back 24. For example, the indentations 82 may be located on or integrated into a vertical portion or length of the seat support 29, the seat support plate 84, or the rail 80 and positioned incrementally or stepwise along the lengthwise or vertical direction of the seat support 29 or seat support plate 84 for vertical adjustment. The engagement between the vertical lock 72 and the indentations 82 may utilize a variety of different mechanisms, including but not limited to at least one lever, detent, latch, pawl lock (with multiple or one part), sliding ratchet, rack and pinion, ratchet brake, flange mount pinion, and/or cam lock.

The projection member 72a is mounted so as to be pivotable about an axis. Pivoting the projection member 72a will cause the projections 74 to be spatially displaced relative to the indentations 82, thereby allowing the vertical lock 72 to be moved between the locked position 71 and the unlocked position 73.

In the locked position 71, the at least one projection 74 is interlocked or engaged with at least one indentation of a series of indentations 82 (as shown in FIGS. 13, 14, and 15) to lock and hold the frame 31 in a particular vertical position along the rail 80. The projections 74 may interlock with different indentations 82 depending on the desired vertical position of the frame 31. Accordingly, the frame 31 may be positionable and lockable at multiple particular vertical positions along the length of travel according to the locations of the indentations 82.

When the vertical lock 72 is moved to the unlocked position 73, the projection member 72a is pulled, which rotates, pivots, or angles the projection member 72a and spatially displaces the projections 74 from the indentations 82, thus disengaging the projections 74 from the indentations 82. In the unlocked position 73, the projections 74 do not extend into any of the indentations 82. Accordingly, the vertical slides 76 may be vertically moveable or slidable along the rails 80, allowing the frame 31 to be raised or lowered.

FIGS. 9 and 17 depict the vertical lock 72 in both the locked position 71 and the unlocked position 73 for comparison between the positions of the projections 74. In the locked position 71, the projection member 72a is substantially perpendicular to the support plate 77 to engage the projections 74 with the indentations 82. In the unlocked position 73, the projection member 72a is angled relative to the support plate 77 to avoid an interaction between the projections 74 and the indentations 82.

The projection member 72a may be preferentially biased to move toward the locked position 71 due to an attached spring 78 (as shown in FIGS. 11-12). The spring 78 may help hold the projection member 72a in the locked position 71.

### The Contour Adjuster

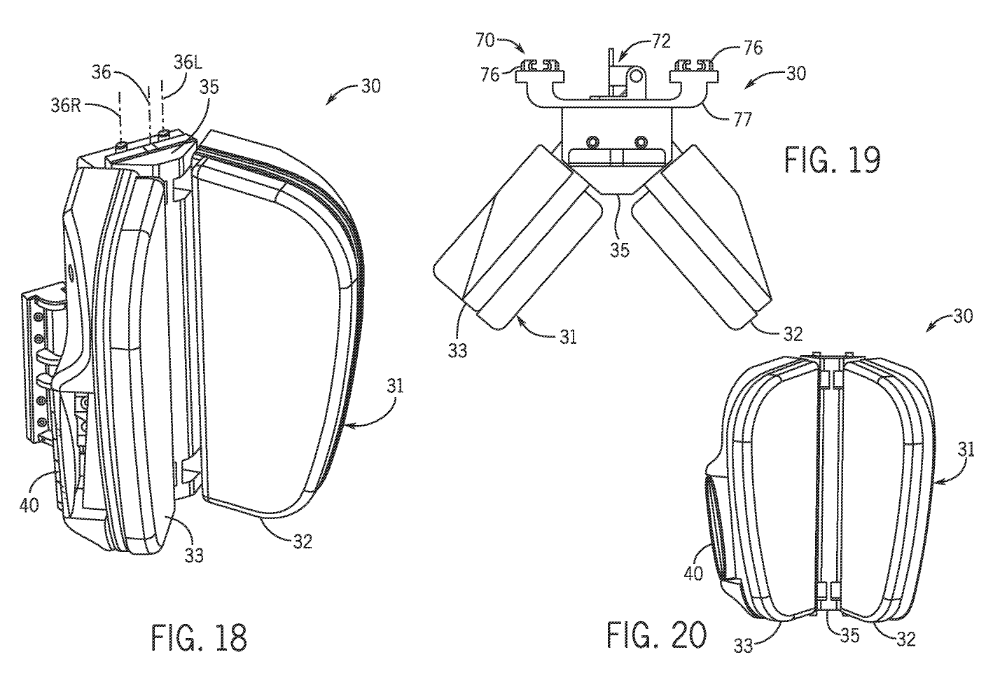

As shown in FIGS. 18-21, the contour adjuster 50 may be used to allow the relative lateral positions of the first and second lateral portions 32 and 33 to be adjusted. Accordingly, the contour or curvature of at least the front side of the frame 31 may be adjusted to fit the head of the occupant according to the occupant's preferences, which may increase the comfort of the head rest 28. This may be particularly beneficial if the occupant has a ponytail or bun protruding from the back of the occupant's head toward the head rest 28. It may be further desirable to provide a head rest 28 that can nestle or hold the occupant's head while the seat back 24 is reclined, thereby preventing the occupant's head from rolling off the head rest 28 while the occupant is sleeping. When the first and second lateral portions 32 and 33 are angled toward each other, the head of the occupant may contact the frame 31 in two separate areas (e.g., the first and second lateral portions 32 and 33).

As can be seen by comparing FIGS. 6-8 with FIGS. 18-20, the contour adjuster 50 may allow the front side of the frame 31 to at least partially fold or flex towards itself along the vertical direction (i.e., the z-axis). The frame 31 may be adjusted in the fore/aft direction by allowing the first lateral portion 32 and the second lateral portion 33 to pivot toward or away from each other along the center axis 36 of the frame 31. For example, FIGS. 6-8 depict the frame 31 with the first and second lateral portions 32 and 33 substantially flat and in line relative to each other such that the angle between the lateral portions 32 and 33 is approximately 180°. FIGS. 18-20 depict the frame 31 with the first and second lateral portions 32 and 33 adjusted such that the front surface of the frame 31 is bent and the lateral portions 32 and 33 are angled toward and at least partially facing each other along the front side of the frame 31. The angle between the lateral portions 32 and 33 along the front side may be less than 180°, according to the user's preference.

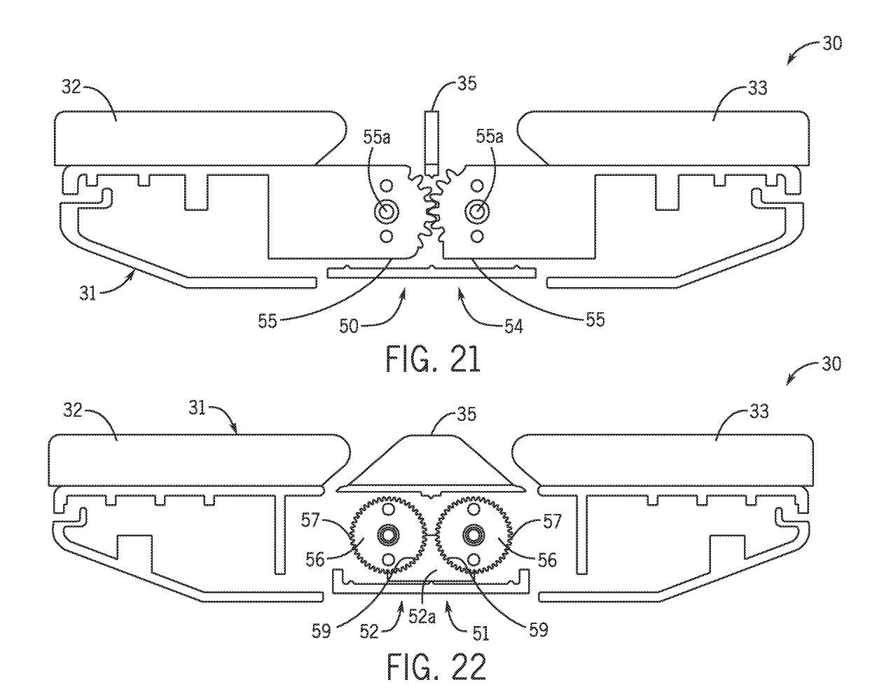

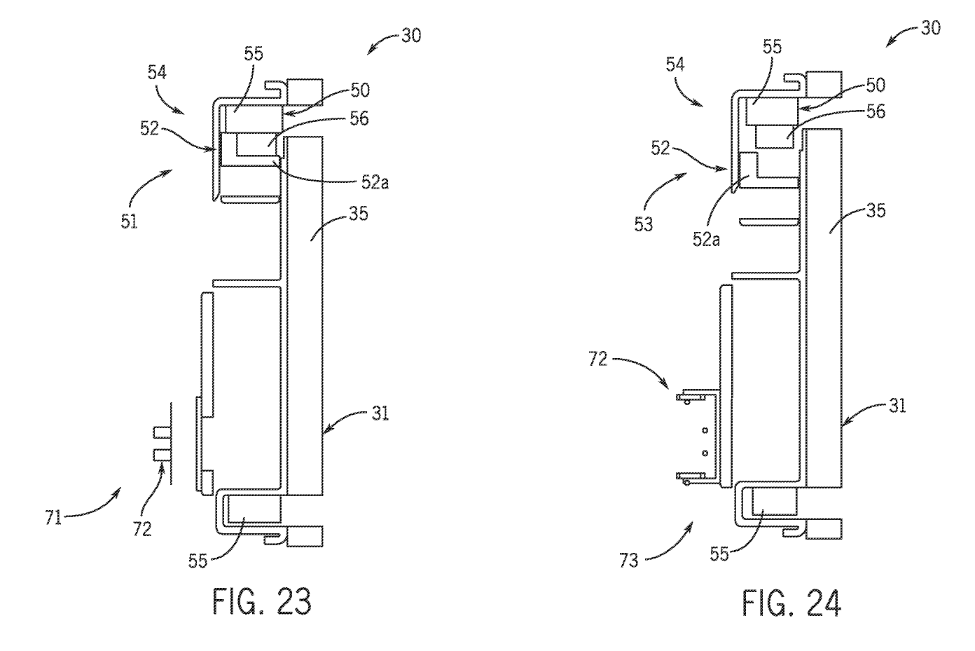

The contour adjuster 50 can include a hinge or pivoting connection 54 that is connected to the first and second lateral portions 32 and 33 and allows the first and second lateral portions 32 and 33 to pivot or rotate substantially about the center axis 36. The pivoting connection 54 may include at least one gear 55 attached to each of the first and second lateral portions 32 and 33. The gears 55 may be fixed in position relative to the respective lateral portions 32 and 33 and may each rotate about a respective axle 55a (as shown in FIG. 21) that is parallel to the center axis 36. The axles 55a will correspond to the axes 36L and 36R. The lateral portions 32 and 33 may optionally include a gear 55 at both a top portion and a bottom portion of the frame 31, as shown in FIGS. 23-24. Accordingly, the pivoting connection 54 may include four gears 55.

The gears 55 on each of the lateral portions 32 and 33 may interlock, interdigitate, or connect with each other to connect the lateral portions 32 and 33 such that adjustment of the lateral position of one of the lateral portions 32 or 33 causes a corresponding, mirrored, and even adjustment of the lateral position of the other of the lateral portions 32 or 33. Accordingly, moving one lateral portion 32 or 33 may automatically result in equal motion of the other lateral portion 32 or 33 due to the gears 55. Therefore, the user may only need to adjust or move one of the lateral portions 32 or 33 to evenly change the contour of the frame 31.

### The Contour Lock

As shown in FIGS. 11-12 and 22-24, a contour lock 52 may be used to lock and unlock the contour adjuster 50 by moving between a locked position 51 and an unlocked position 53. When the contour lock 52 is in the locked position 51, the contour adjuster 50 is locked, thus preventing adjustment of the lateral positions of the first and second lateral portions 32 and 33 and maintaining the contour of the frame 31. When the contour lock 52 is in the unlocked position 53, the contour adjuster 50 is unlocked, thus allowing adjustment of the lateral positions of the lateral portions 32 and 33.

The contour lock 52 can include gear mechanisms 56 that are spatially fixed relative to the respective first and second lateral portions 32 and 33. The gear mechanism 56 can include vertically extending gear teeth 57. The contour lock 52 may further include a locking member 52a that is a locking gear or a substantially straight piece (along the vertical direction) with vertically-extending lock teeth 59 that are complementary to vertically-extending gear teeth 57 of the gear mechanism 56. The locking member 52a may be positioned or oriented within or on the frame 31 such that the locking member 52a may engage or interlock with gear mechanisms 56 on each of the first and second lateral portions 32 and 33 in the locked position 51. As shown in FIGS. 11-12, the contour lock 52 may be in a middle portion of the back side of the frame 31. The lock teeth 59 of the locking member 52a and the gear teeth 57 of the gear mechanism 56 may be relatively finer or smaller than the gear teeth of each of the gears 55 for greater control of the locking and an increased number of positions that the first and second lateral portions 32 and 33 may be locked into.

The locking member 52a is mounted so as to be slidable in the vertical direction. Such sliding movement of the locking member 52a will cause its lock teeth 59 to be spatially displaced relative to the gear teeth 57 of the gear mechanisms 56, thereby allowing the contour lock 52 to be moved between its locked position 51 and its unlocked position 53.

In the locked position 51 (as shown in FIGS. 22 and 23), lock teeth 59 of the locking member 52a may interlock, mate, or engage with gear teeth 57 of at least one of the gear mechanisms 56. Since the locking member 52a is not rotatable, the locking member 52a prevents the gear mechanisms 56 from rotating or moving, thus locking the two lateral portions 32 and 33 into their current lateral positions and preventing further rotation or pivoting. Since the gear mechanisms 56 may be statically attached a respective gear 55 and thus rotate in unison (as shown in FIGS. 23-24), the gears 55 (and their respective lateral portion 32 or 33) may not rotate when the gear mechanisms 56 are prevented from rotating.

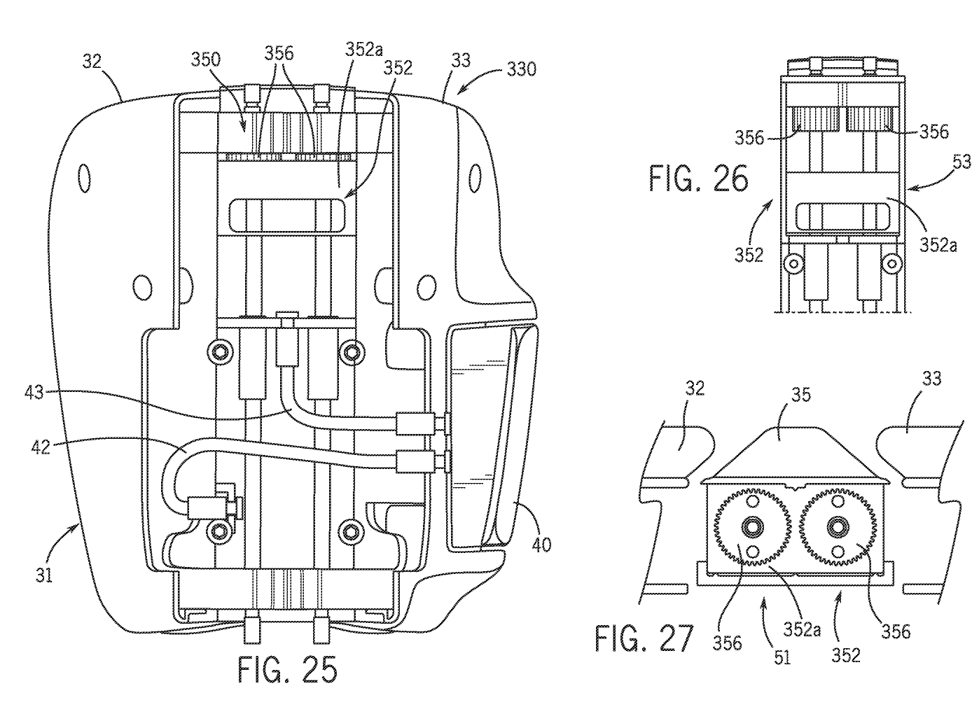

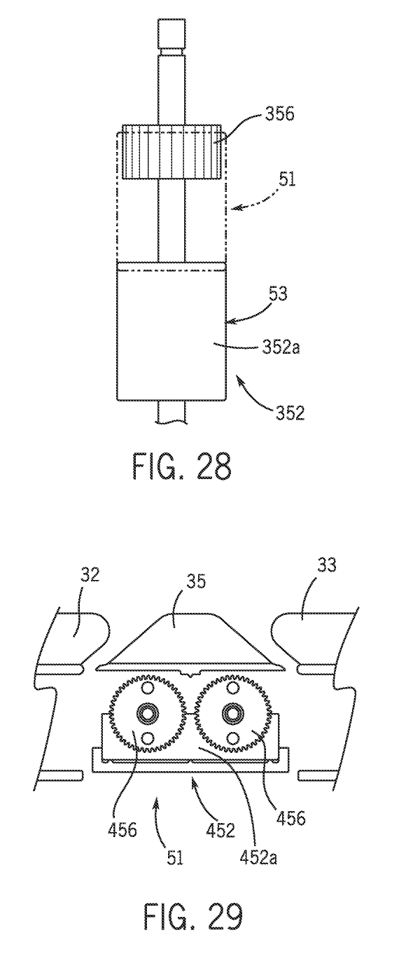

As shown in FIG. 22, the locking member 52a may engage with approximately one quarter of the perimeter of each of the gear mechanisms 56 in the locked position 51. However, according to another embodiment of a contour adjuster 350 of an adjustment mechanism 330 (as shown in FIGS. 25-28), the contour lock 352 may have a locking member 352a that fully encapsulates and engages with the entire outer perimeter of the gear mechanisms 356 in the locked position 51 for increased control and strength of the contour lock 352. According to yet another embodiment of a contour adjuster 450 as shown in FIG. 29, the contour lock 452 may have a locking member 452a that engages with approximately one half of the perimeter of each of the gear mechanisms 456 in the locked position 51.

When the vertical lock 72 is moved to the unlocked position 73, the locking member 52a is pulled vertically (e.g., along the z-axis) out of engagement with the gear mechanisms 56 to release the gear mechanisms 56, as shown in FIG. 24. Accordingly, the gear mechanisms 56 (and thus the gears 55 with the lateral portions 32 and 33) are free to rotate relative to each other to adjust the contour of the frame 31.

FIGS. 9 and 23-24 depict the contour lock 52 in the locked position 51 and the unlocked position 53 for comparison between the positions of the contour lock 52 relative to the gear mechanisms 56. In the locked position 51, the locking member 52a may surround and interlock with at least a portion of the gear mechanisms 56. In the unlocked position 53, the locking member 52a is moved beneath the gear mechanisms 56 to avoid an interaction between the locking member 52a and the gear mechanisms 56.

The locking member 52a may be preferentially biased to move toward the locked position 51 due to at least one integrated spring 58. The spring 58 may push the locking member 52a toward the gear mechanisms 56 for engagement, as shown in FIGS. 11-12 and 14.

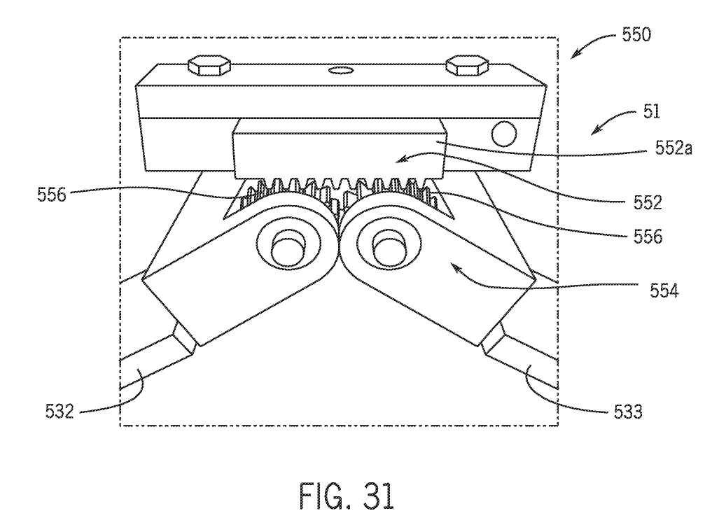

According to another embodiment of a contour adjuster 550 of an adjustment mechanism 530 (as shown in FIGS. 30-31), the first and second lateral portions 532 and 533 of the frame 531 each include a gear mechanism 556 that directly engage or interlock with each other to create a pivoting connection 554 for the contour of the frame 531 to be adjusted. The contour lock 552 may include a locking member 552a that directly engages with each of the gear mechanisms 556 in the locked position 51. Additionally, the frame 531 may not include a center portion 35 and, as mentioned previously, the vertical lock 572 may include four projections 574 in order to lock the vertical adjuster 570.

### The User Interface

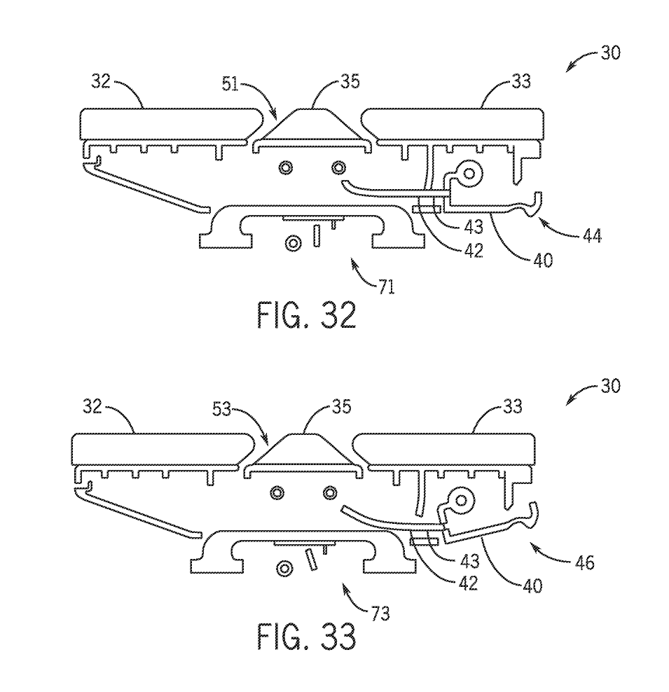

As shown in FIGS. 32-33, the adjustment mechanism 30 may include a handle, lever, release, paddle, control, or user interface 40 that may be configured to be engaged by a user in order to simultaneously control the vertical lock 72 and the contour lock 52. For example, actuation of the user interface 40 may simultaneously move the vertical lock 72 between the locked position 71 and the unlocked position 73 and move the contour lock 52 between the locked position 51 and the unlocked position 73. By activating or moving the user interface 40 (e.g., by squeezing or pulling the user interface 40 forward toward the front side of the frame 31), the user may move the user interface 40 between an engaged or locked position 44 and a disengaged or unlocked position 46. In the locked position 44, both the vertical lock 72 and the contour lock 52 are in the locked positions 71 and 51, respectively, and the frame 31 is held in a stable position. In the unlocked position 46, both the vertical lock 72 and the contour lock 52 are unlocked or released into the unlocked positions 73 and 53, respectively. Accordingly, the user can adjust both the vertical position and the contour of the frame 31 at the same time when the user interface 40 is in the unlocked position 46. However, it is anticipated that each of the adjusters 50 and 70 may have a separate user interface 40, as shown in FIGS. 4 and 5.

As shown in FIGS. 11-12, a first flexible linkage 42 may connect the user interface 40 to the vertical lock 72 to control movement of the vertical lock 72 and a second flexible linkage 43 may connect the user interface 40 to the contour lock 52 to control movement of the contour lock 52. The flexible linkages 42 and 43 may optionally be cables that are housed in and may move within a lumen or shaft. When the user interface 40 is moved into the unlocked position 46, the first and second flexible linkages 42 and 43 are flexed, tensed, stretched, or pulled, causing the projection member 72a of the vertical lock 72 and the locking member 52a of the contour lock 52 to move into the unlocked positions 73 and 53 and to release the vertical adjuster 70 and the contour adjuster 50, respectively. More specifically, the first flexible linkage 42 may move or rotate the projection member 72a out of engagement with the indentations 82 into the unlocked position 73 and the second flexible linkage 43 may move or pull the locking member 52a out of engagement with the gear mechanisms 56 into the unlocked position 53. When the user interface 40 is in the unlocked position 46, the flexible linkages 42 and 43 may overcome the spring forces of the springs 78 and 58, respectively. The springs 78 and 58 may be compressed while the user interface 40 is in the unlocked position 46. According to another embodiment, the user interface 40 may be directly connected to the vertical lock 72 and connected to the contour lock 52 through the flexible linkage 43.

Once the frame 31 has been adjusted according to the user's preferences, the user interface 40 may be released, which allows the user interface 40 to move back into the locked position 44. Accordingly, the flexible linkages 42 and 43 may relax, allowing the vertical lock 72 and the contour lock 52 to move back into the locked positions 71 and 51, respectively. The user interface 40 may be preferentially biased to move toward the locked position 44 due to at least one spring (not shown) acting on the user interface 40 and/or in response to the springs 78 and 58 acting on the vertical lock 72 and the contour lock 52, respectively.

Due to the flexible linkages 42 and 43, the user interface 40 may be located anywhere along the frame 31. In order to be convenient, easily accessed, and ergonomic for the user to access and move the user interface 40 to the unlocked position 46 and adjust the frame 31, the user interface 40 may be located along or disposed at one of the two lateral side regions 66 of the frame 31 (as shown in FIG. 10), such that the user can access the user interface 40 from one of the lateral side region 66. The lateral side regions 66 may include a portion of the back side of the frame 31. As shown in FIGS. 6 and 10, the frame 31 may include an upper side region 62, a lower side region 64, and the two lateral side regions 66 between the upper side region 62 and the lower side region 64. The user interface 40 may pivot about a substantially vertical axis (e.g., an axis approximately parallel to the z-axis) or an axis at a slight angle to the z-axis.

Due to the dual locking mechanisms and the corresponding adjustment of the first and second lateral portions 32 and 33, only one hand is required to unlock and adjust the frame 31. While the user is squeezing the user interface 40 into the unlocked position 46 with one hand, the user may adjust the vertical position and/or the contour of the frame 31 with the same hand since the user may grip both the user interface 40 and the frame 31 at the same time.

Since each of the locking efforts (i.e., the vertical lock 72 and the contour lock 52) are decoupled from the each of the adjusters (i.e., the vertical adjuster 70 and the contour adjuster 50, respectively), the frame 31 is easily adjusted with low efforts since the vertical lock 72 and the contour lock 52 are completely disengaged in the unlocked positions 73 and 53 and the frame 31 does not rely on a high sliding friction to prevent the frame 31 from making noise or vibrating.

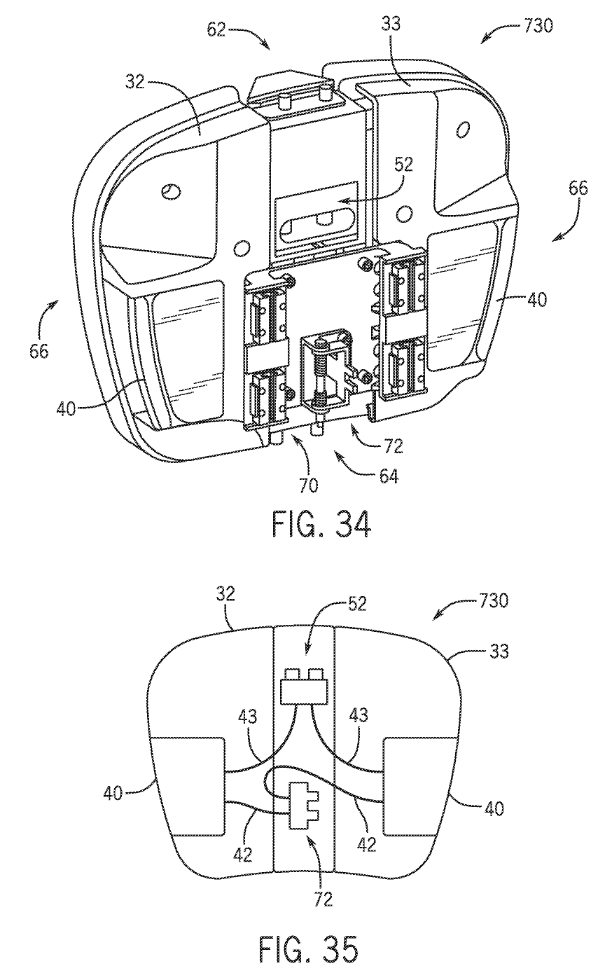

The user interface 40 may be located on either lateral side region 66 of the frame 31 (i.e., the left lateral side region or the right lateral side region) and therefore on either the first lateral portion 32 or the second lateral portion 33. According to another embodiment as shown in FIGS. 34-35, the adjustment mechanism 730 may include two user interfaces 40. The user interfaces 40 may be positioned on each of the first and second lateral portions 32 and on each of the lateral side regions 66 of the frame 31. This configuration may allow the user to choose between right-handed or left-handed adjustment according to their preference. As shown in FIG. 35, both of the user interfaces 40 may be connected to the vertical lock 72 through separate first flexible linkages 42 and to the contour lock 52 through separate second flexible linkages 43 such that either user interface 40 may be used to control the vertical lock 72 and the contour lock 52, as described previously. Accordingly, when either one of the user interfaces 40 is actuated into the unlocked position 46, the vertical lock 72 and the contour lock 52 are moved to the unlocked positions 73 and 53, respectively, to allow the vertical position and the contour of the frame 31 to be adjusted. When neither user interface 40 is actuated (and thus both user interfaces 40 are in the locked position 44), the vertical lock 72 and the contour lock 52 are in the locked positions 71 and 51, respectively.

### The Noise Dampers

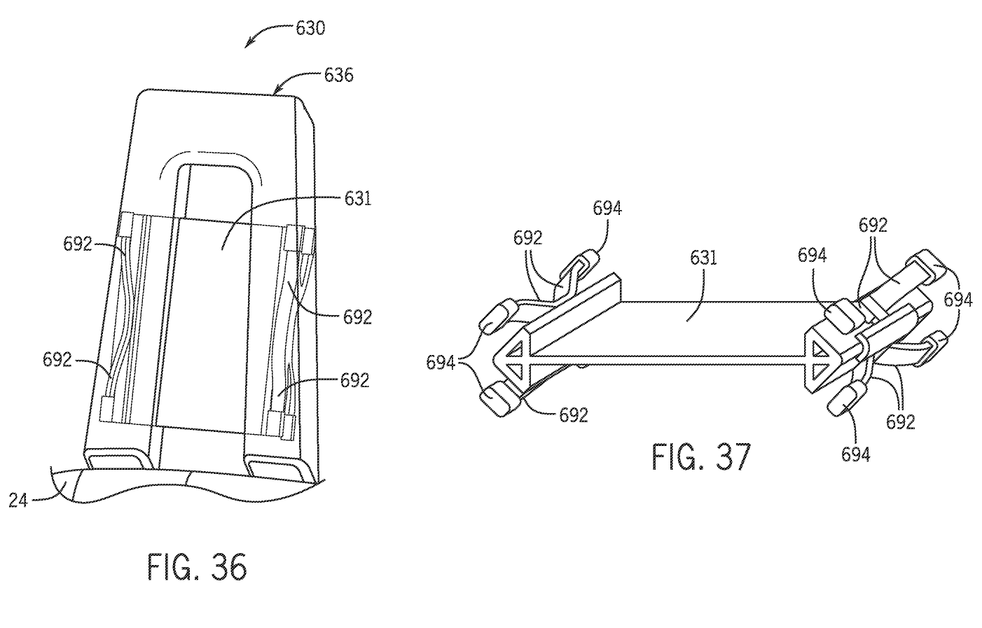

As shown in FIGS. 36-37, the frame 631 of the adjustment mechanism 630 may include rubber portions, buffer pads, or dampers 694 to reduce the “buzz, squeak, rattle” (BSR) and “noise, vibration, harshness” (NVH) of the adjustment mechanism 630. The dampers 694 may frictionally engage with the seat support 636 of the seat 23 in order to absorb vibrations and reduce the noise. Additionally, the dampers 694 may distribute the sliding surface of the frame 631 on the seat support 636 over a larger surface area. It is understood that the dampers 694 may be integrated into any of the aforementioned embodiments.

The dampers 694 may be positioned on the end of slide members or spring arms 692 that protrude from the frame 631. The spring arms 692 may be flat springs and may expand or press outward from the frame 631 and toward a portion of the seat support 636, such as the rail 80. Each side of the frame 631 may have any number of spring arms 692. As shown in FIGS. 36-37, the frame 631 may have four spring arms 692 on each lateral side and the spring arms 692 may extend parallel to the z-axis of the frame 631. The spring arms 692 may also include the various features of the vertical slide 76.

The adjustment mechanism 30 may be integrated into the seat back 24 and may not be removable. However, according to another embodiment, the adjustment mechanism 30 may be an add-on component to the seat back 24. For example, the frame 31 may attach to the seat support 29 by unlocking the vertical lock 72 and sliding the vertical slide 76 over the rail 80.

The adjustment mechanism may further utilize other mechanisms to provide sufficient force and locking and to manage the loads such as shear or frictional forces of using rheological fluid, a piezo lock, and/or a hydraulic or pneumatic lock.

The embodiments disclosed herein allow the height and/or curvature of a frame for a head restraint to be adjusted according to the user's preference. Besides those embodiments depicted in the figures and described in the above description, other embodiments of the present invention are also contemplated. For example, any single feature of one embodiment of the present invention may be used in any other embodiment of the present invention.

Given the disclosure of the present invention, one versed in the art would appreciate that there may be other embodiments and modifications within the scope and spirit of the invention. Accordingly, all modifications attainable by one versed in the art from the present invention within the scope and spirit of the present invention are to be included as further embodiments of the present invention.

What is claimed is:

1. A vertical and contour adjustment mechanism for a head restraint, comprising:
a frame including a first lateral portion and a second lateral portion;
a vertical adjuster configured to allow adjustment of a vertical position of the frame;
a vertical lock movable between a locked position, in which the vertical adjuster is locked to prevent adjustment of the vertical position of the frame, and an unlocked position, in which the vertical adjuster is unlocked to allow adjustment of the vertical position of the frame;
a contour adjuster configured to allow adjustment of lateral positions of the first lateral portion and the second lateral portion;
a contour lock movable between a locked position, in which the contour adjuster is locked to prevent adjustment of the lateral positions of the first and second lateral portions, and an unlocked position, in which the contour adjuster is unlocked to allow adjustment of the lateral positions of the first and second lateral portions; and
a user interface configured to be engaged by a user to simultaneously control movement of the vertical lock between the locked position and the unlocked position and control movement of the contour lock between the locked position and the unlocked position.

2. The vertical and contour adjustment mechanism of claim 1, wherein the vertical lock includes at least one projection configured to interlock with at least one of a series of indentations in the locked position.

3. The vertical and contour adjustment mechanism of claim 1, further comprising a pivoting connection, wherein the first and second lateral portions are connected to the pivoting connection so as to pivot substantially about a center axis disposed substantially at a center of the frame.

4. The vertical and contour adjustment mechanism of claim 1, wherein the contour adjuster includes a gear mechanism on each of the first lateral portion and the second lateral portion, wherein each of the gear mechanisms includes gear teeth and the contour lock includes lock teeth that interlock with the gear teeth in the locked position.

5. The vertical and contour adjustment mechanism of claim 1, wherein the frame includes an upper side region, a lower side region, and two lateral side regions between the upper side region and the lower side region, wherein the user interface is disposed at one of the two lateral side regions.

6. The vertical and contour adjustment mechanism of claim 1, further comprising a first flexible linkage connecting the user interface and the vertical lock to control movement of the vertical lock, and a second flexible linkage connecting the user interface and the contour lock to control movement of the contour lock.

7. A vertical adjustment mechanism for a head restraint, comprising:
a frame;
a vertical adjuster configured to allow adjustment of a vertical position of the frame;
a vertical lock movable between a locked position, in which the vertical adjuster is locked to prevent adjustment of the vertical position of the frame, and an unlocked position, in which the vertical adjuster is unlocked to allow adjustment of the vertical position of the frame;
a user interface configured to be engaged by a user to control movement of the vertical lock between the locked position and the unlocked position; and
a flexible linkage connecting the user interface and the vertical lock to control movement of the vertical lock.

8. The vertical adjustment mechanism of claim 7, wherein the vertical lock includes at least one projection configured to interlock with at least one of a series of indentations in the locked position.

9. The vertical adjustment mechanism of claim 7, wherein the flexible linkage is a cable configured to move the vertical lock.

10. The vertical adjustment mechanism of claim 7, wherein the frame includes an upper side region, a lower side region, and two lateral side regions between the upper side region and the lower side region, wherein the user interface is disposed at one of the two lateral side regions.

11. A contour adjustment mechanism for a head restraint, comprising:
a frame including a first lateral portion and a second lateral portion;
a contour adjuster configured to allow adjustment of lateral positions of the first lateral portion and the second lateral portion, wherein the contour adjuster includes a gear mechanism on each of the first lateral portion and the second lateral portion and adjustment of the lateral position of one of the first and second lateral portions causes a corresponding adjustment of the lateral position of the other of the first and second lateral portions;
a contour lock movable between a locked position, in which the contour adjuster is locked to prevent adjustment of the lateral positions of the first and second lateral portions, and an unlocked position, in which the contour adjuster is unlocked to allow adjustment of the lateral positions of the first and second lateral portions; and
a user interface configured to be engaged by a user to control movement of the contour lock between the locked position and the unlocked position.

12. The contour adjustment mechanism of claim 11, further comprising a pivoting connection, wherein the first and second lateral portions are connected to the pivoting connection so as to pivot substantially about a center axis disposed substantially at a center of the frame.

13. The contour adjustment mechanism of claim 11, wherein each of the gear mechanisms includes gear teeth and the contour lock includes lock teeth that interlock with the gear teeth in the locked position.

14. The contour adjustment mechanism of claim 11, wherein the frame includes an upper side region, a lower side region, and two lateral side regions between the upper side region and the lower side region, wherein the user interface is disposed at one of the two lateral side regions.

15. The contour adjustment mechanism of claim 11, further comprising a flexible linkage connecting the user interface and the contour lock to control movement of the contour lock.
